(19) United States
(12) Patent Application Publication
(10) Pub. No.: US 2007/0050262 A1
(43) Pub. Date: Mar. 1, 2007

(54) Multimedia purchasing apparatus, purchasing and supplying method

(75) Inventors: Albertus Josephus Nicolaas Van Breemen, Eindhoven (NL); Sander Bastien Reerink, Oldemzaal (NL); Laurentius Michiel Gerdardus Feijs, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/558,713

(22) PCT Filed: May 27, 2004
(86) PCT No.: PCT/IB04/50787

§ 371 Date: Nov. 29, 2005

(30) Foreign Application Priority Data
Jun. 3, 2003 (EP) 031016082

(51) Int. Cl. G06Q 30/00

(52) U.S. Cl. 705/26

(57) ABSTRACT

The multimedia purchasing apparatus (100) for purchasing multimedia content (161) over a network (140), interacting with a user profiling unit (122) containing information on user preferences of multimedia, has a user negotiation unit (120) comprised, which is arranged to autonomously purchase the multimedia content (161) guided by a budget specification (114). Different negotiation strategies may be used to purchase content as desired by the user.

The invention relates to a multimedia purchasing apparatus for purchasing a multimedia item over a network, interacting with a user-profiling unit containing information on user preferences of multimedia.

The invention also relates to a method of purchasing a multimedia item over a network, taking into account user information from a user-profiling unit, containing information on user preferences of multimedia.

The invention also relates to a method of supplying a multimedia item over a network, taking into account user information from a user profiling unit containing information on user preferences of multimedia.

The invention also relates to a computer program product comprising code enabling a processor to execute the purchasing method.

The purchasing of multimedia items can according to prior art be done in a number of different ways, which can be organized on a scale denoting a level of specification of the items. Usually a user has to pay one way or the other for obtained items, regardless of whether he likes the items. At the upper end of the scale there is plain radio and television, which in a number of countries requires a radio or television license, typically paid yearly. Although the system is not too expensive the user has no way of specifying what he obtains. Also, a large fraction of the cost of radio and television program making is paid for by advertising, which is typically not liked by the user. At the lower end there is the possibility of buying a specific multimedia item, e.g. a CD of Madonna, in a shop or over the Internet. A disadvantage of this approach is that a user needs to search for a very specific item, which between the tens of thousands of movies, hundredths of thousands pieces of music or millions of books may be a daunting task. This has typically led to a situation in which there are only a small number of items presented anyway. E.g. in a book store only a selection of the most recent popular books are presented, and after a short period of time, books may only be available in other circuits such as from dedicated vendors of previous prints or second hand vendors. So a user usually does not even know what items exist that may be of interest to him, and if he did, he would have a hard time finding out who could sell those items.

In between the ends are methods to subscribe to a dedicated payTV service, which delivers e.g. sports, or movies, such as FilmNet. Although in the FilmNet example a user has at his disposition a larger collection of movies than on any normal TV channel, he still only has the option to choose from what is provided.

At a level of somewhat more control over the specification of obtained items, is a method disclosed in WO-A-02/27986 to purchase multimedia items, with a variant of the apparatus of the opening paragraph. It is a method for transmitting a personalized radio program to a mobile user terminal. Music and news may be downloaded from a database of a service provider over a Universal Mobile Telecommunications System (UMTS) network. At the provider's side, there is a user agent piece of software running, a simple embodiment of the user profiling unit according to the invention, which takes on the role of a personalized disk jockey (DJ), composing a radio program more or less according to the likings of the user. Different payment models are proposed which are all “global” payment models, i.e. the user pays fixed amounts regardless of the importance of the items to him, similar to what is known from pay-TV. Namely, a user can pay an “all in” subscription for a fixed amount of time, or pay a fixed amount for each downloaded or received item. To give the user some control over the items that the user agent puts in his personalized radio program, the user can influence the percentages of different kinds of multimedia item, e.g.: no sports information, 20% recent pop music, 30% jazz, etc.

It is a disadvantage of the known apparatus that in such a personalized radio system there will still be relatively many items purchased which the user does not really like, whereas on the other hand there are still a lot of desired items which he cannot obtain, because e.g. they are not in the provider's database. In other words the known method and apparatus are still too provider specific and too coarse in specifying user desires.

It is a first object of the invention to provide a multimedia purchasing apparatus of the kind mentioned in the opening paragraph, which is arranged to provide for a better user specification of the multimedia items to purchase.

This first object is realized in that a user negotiation unit is comprised, arranged to autonomously purchase the multimedia item guided by a budget specification, and the user-profiling unit is comprised in the multimedia purchasing apparatus. The user-profiling unit of the prior art document is relatively simple. A user just specifies what he likes as percentages of types of music in the personalized radio program, not individual pieces or groups of pieces of music. The formulation of user preferences is also simple, namely a user can use a keyboard to input information like “I want more of this kind of multimedia”, or “I don't want this kind of multimedia”. In the former case if the multimedia currently playing was labeled as “recent news”, the percentage of this in the personalized radio program would increase. The user-profiling unit according to the invention is more complex, in that it contains a more detailed description of the user's preferences. E.g. it may know that in the evening the user likes to hear Jazz, or that he is a Madonna fan, or even that he is looking for a specific Madonna song.

The user negotiation unit can autonomously search for such better specified items of multimedia on the network and buy them. The user has then bought multimedia of which most items are of his liking, rather than just having a subscription to a personalized radio program, which only on average is not too unsuited for the user. The advantage of an autonomously purchasing user negotiation unit is that the tedious effort of looking on the network for the right songs is taken out of the user's hand. When he's coming home in the evening, the jazz items are already downloaded and purchased. Even when looking for the single Madonna song, a user may spend too much of his precious time looking for a provider which offers the song at a good price. Allowing a piece of technology to spend your money requires a good deal of faith. The user-profiling unit should be reasonably in tune with what the user really likes. Since it contains a lot of sensitive information on the user, preferably the bulk of this information resides in the multimedia purchasing apparatus and not with a provider. This also means that you can carry your personalized device with you and download personalized items from whatever provider, rather than relying on possibly outdated information residing with a few providers. To avoid that too much money is spent on the wrong multimedia items—in contrast with personalized radio where a user may know in advance that he is not going to spend more than the yearly subscription—, a budget specification is comprised, which guides, and typically limits, the actions of the user negotiation unit. E.g. the user may like science fiction (SCIFI) movies and allocate a rather large budget for this, since even if the user negotiation unit purchases a very old science fiction movie, the user will still like it. But he may specify the evening jazz budget to be more limited. While the user enjoys the advantage of more easily finding the right music, a provider may sell more multimedia items, which would otherwise remain obscured, and he has a higher certainty regarding the purchase, whereas otherwise more items would be obtained illegally. The apparatus according to the invention should be contrasted with video on demand services, in which a user himself buys a specific multimedia item, e.g. a movie, which he typically is allowed to see an unlimited amount of times during 24 hours. The purchase is usually done in response to publicity for the movie. The multimedia purchasing apparatus according to the invention is actively purchasing items anywhere on the network, and the item is typically only rather specific in that it is an item from a cluster of items, e.g. a song of Madonna, rather than exactly the “Pappa don't preach” song. Of course the apparatus could also be requested to look for a particular song, but then it is still actively searching the network, coming up with a reasonably cheap version in an optimal time. The apparatus can be configured on a scale of specificity ranging from dedicated search to browsing, in accordance with how a user typically purchases. E.g., when a user pushes a “surprise me” button, the system may browse items from related clusters up to even near randomly, just as if a user was looking for what new furniture was present in a furniture store.

In an embodiment, the budget specification comprises type budgets for different types of multimedia item. Instead of allocating a global budget, which may not be exceeded, finer specification of the purchasing according to the user's preferences can be achieved by specifying sub budgets. An advantageous way to do this is by specifying budgets for different types of multimedia which the user may like, which budgets typically correspond to clusters in a feature space characterizing the multimedia. E.g. an electronic program guide (EPG) may specify that a movie is a science fiction movie, or a label such as an ID3 tag may specify that a piece of music is of Madonna or of the genre techno.

In a further modification of the previous embodiment, the type budgets are subdivided in sub ranges. Instead of allowing the user negotiation unit to purchase until the budget is totally spent, finer budget specification may be desirable. This is in accordance with how a user would buy his multimedia items. He would typically not always spend the full budget, and on the other hand there should be some spending margin for the case where a provider offers a great deal on a rare item.

In another modification of the previous embodiment, a type budget is associated a quota of items of the type. Just specifying a budget enables a user to have control over the amount of his money spent by the user negotiation unit. However, this does not indicate how valuable the multimedia items are to the user. When the monthly budget for Jazz is 2 euro, either 100 songs of 2 euro cent may be purchased or 2 songs of 1 euro, the latter case probably leaving the user feeling cheated. He can also e.g. specify that whatever the budget for jazz currently spent, 100 songs is enough. Advanced versions of this and the above modification allow for the specification of a detailed sub budget specification: e.g. up to stating that three particular songs are allowed to cost respectively x, y and z euro.

In another embodiment, the budget specification comprises budgets for different periods. Since a user's taste evolves over time, it is advantageous to determine different specifications for different time periods. E.g. the user may have a different spending behavior during his summer holiday than during the Christmas season, in which latter case he may not be buying mostly for himself, but for a second user being his partner.

It is advantageous if braking means are comprised, arranged to diminish multimedia purchasing when an absolute value of a derivative of a budget is above a predefined threshold. Having e.g. a monthly budget for jazz, the user negotiation unit may be spending too much money during the first days of the month, in which case there will not be enough money for that rare purchasing occasion at the end of the month, unless the user negotiation unit asks the user to replenish the jazz budget. The user negotiation unit may be arranged to use the user interface for contacting the user for a budget replenishment if the budget is below a value. It is likely that the user's money was not spent too well these first days anyway. By looking at the evolution of spending, e.g. by calculating the derivative of the budget spending over a day, the user negotiation unit can become more restricted in spending the following days. Different heuristic formulae can be applied for the braking action.

An aware embodiment of the multimedia purchasing apparatus comprises a user behavior sensing unit, arranged to obtain information on behavior of a user. A user may input all his preferences manually by means of a data input means like a keyboard. However an apparatus with a complex user-profiling unit, needing a lot of accurate user preference data may be a lot more acceptable to a user if it can obtain at least part of this information itself. If e.g. the multimedia purchasing apparatus is part of a personal digital assistant (PDA), the user behavior sensing unit may dispose of the information that the user has visited a “Star Wars” movie on November the 5^{th}, since the tickets were purchased with the aid of the PDA. The user-profiling unit, having the knowledge that a user is always enthusiastic on buying related items after seeing a science fiction movie, may then buy the sound track. The user behavior-sensing unit may also be linked with all kinds of sensors in an intelligent home, e.g. a camera. If image processing software, e.g. a face recognition software or other user tracking software coupled with motion estimation software, identifies that the user has fallen asleep on the couch, the purchasing of techno music for later in the evening may be suspended or at least reduced, since the user is going to sleep for at least part of the evening.

With this user behavior sensing unit present, it may also be arranged to directly determine some of the type budgets on the basis of the information of the user behavior sensing unit, e.g. relaxing music if the user appears listless or sick lately. For this a user activity monitor based on video footage may be employed.

In another embodiment, the budgets for different periods are determined as a function of a temporal difference between the periods and a time instant. E.g. in the example where the user has seen “Star Wars”, his interest may diminish over time. The “Star Wars” budget may be specified as a decreasing exponential function starting from the time instant on which the user has seen the movie. The buying may also be anticipatory, increasing towards the time instant of seeing the movie, to give a foretaste. Since this may be in the interest of a provider of the star wars movie, the multimedia items may be purchased cheaper with such a strategy.

In entertainment coordination embodiments, the multimedia purchasing apparatus comprises an entertainment coordination unit, arranged to produce a schedule of multimedia items. If items are purchased for a party—in real time or in advance—the entertainment coordination unit may play the songs sequentially during the party. If the user behavior sensing unit is present, the entertainment coordination unit may use behavior information of the users and schedule different music depending on whether the guests are talking in the drawing room or eating at the dinner table. The entertainment coordination unit may also generate a playlist of songs for sports training the next morning, and download them to a portable audio player, via a wired or wireless connection.

In a secured embodiment, the multimedia purchasing apparatus comprises a verification unit arranged to secure access to the budget specification. Specifying how your money should be spent, or loading more budget in a device, should not be allowed to be done by just everybody. The verification unit may e.g. be a fingerprint sensor attached to the data input means, or a smart card reading terminal for entering a debit card with a fixed amount of money on it.

A suggestion receiving embodiment of the multimedia purchasing apparatus comprises a suggestion reception unit arranged to receive a suggestion and transmit it to the user negotiation unit. E.g. friends or peers may make suggestions on very good science fiction movies, and the user negotiation unit may buy them or even re-specify the science fiction budget.

An identifying embodiment comprises a provider database in memory which comprises data on providers of multimedia content. E.g., in it can be stored which provider is cheap for science fiction or stores very rare science fiction items.

In a variant of the previous embodiment, the user negotiation unit is arranged to purchase linked items of multimedia in which at least one item is substantially free of charge. E.g. a low quality version of a movie may be obtained via the terrestrial television broadcast, and a high resolution enhancement may be obtained from an Internet server, at a lower cost than when all the high resolution data has to be transferred.

In another variant of the previous embodiment, the user negotiation unit is arranged to propose a package deal for a set of multimedia items to a provider of multimedia content. E.g. a provider may ask a lower price for a science fiction movie, if you buy at the same time the sound track CD, or another CD. Hence given the desirability of this CD to the user, this package deal may be more interesting than buying just the movie at a lower price from another provider. The user negotiation unit can propose package deals itself, given the user preferences, and negotiate these with a provider negotiation unit, having economical preferences of itself, until a deal is struck.

It is a second object of the invention to provide a multimedia purchasing method of the kind mentioned in the opening paragraph which provides for a better user specification of the multimedia item to purchase. The second object is realized in that the multimedia item is purchased autonomously by a multimedia purchasing apparatus, guided by a budget specification. Together with the budget specification, user preference information from the user profiling unit may be used to guide the purchase. The budget specification may be specified by means of the user preference information.

It is a third object of the invention to provide an multimedia supplying method of the kind mentioned in the opening paragraph which supplies multimedia which is more in tune with a user's requests. The third object is realized in that the multimedia item is supplied in response to an autonomous purchase request from a multimedia purchasing apparatus, guided by a budget specification. An apparatus may identify itself: that it is an autonomous buyer rather than a buyer under user control, e.g. for legal aspects. This can be done e.g. by transferring a standard code or a code identifying the apparatus type. A provider server can negotiate with an autonomously purchasing apparatus at a very high speed compared to when user input is required.

The purchasing method may be realized as code in a computer program product, the code realizing parts required for the method to work such as e.g. negotiation rules, algorithms to characterize multimedia item—such as an algorithm for calculating the tempo of a piece of music—, etc.

These and other aspects of the multimedia purchasing apparatus according to the invention will be apparent from and elucidated with reference to the implementations and embodiments described hereinafter, and with reference to the accompanying drawings, which serve merely as non-limiting illustrations.

In the drawings:

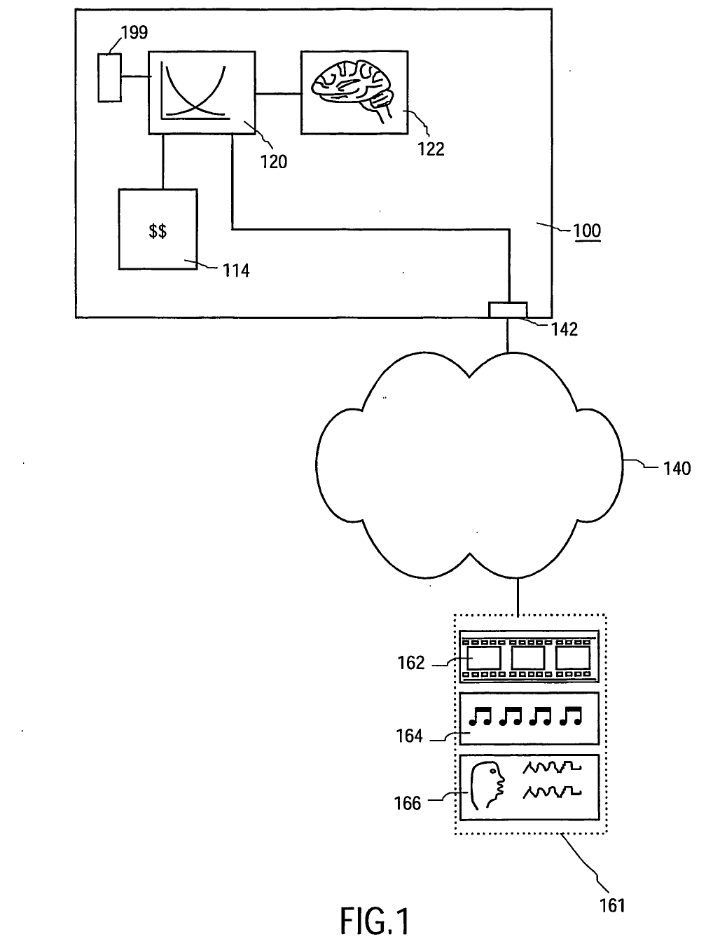

FIG. 1 schematically shows an embodiment of the multimedia purchasing apparatus according to the invention;

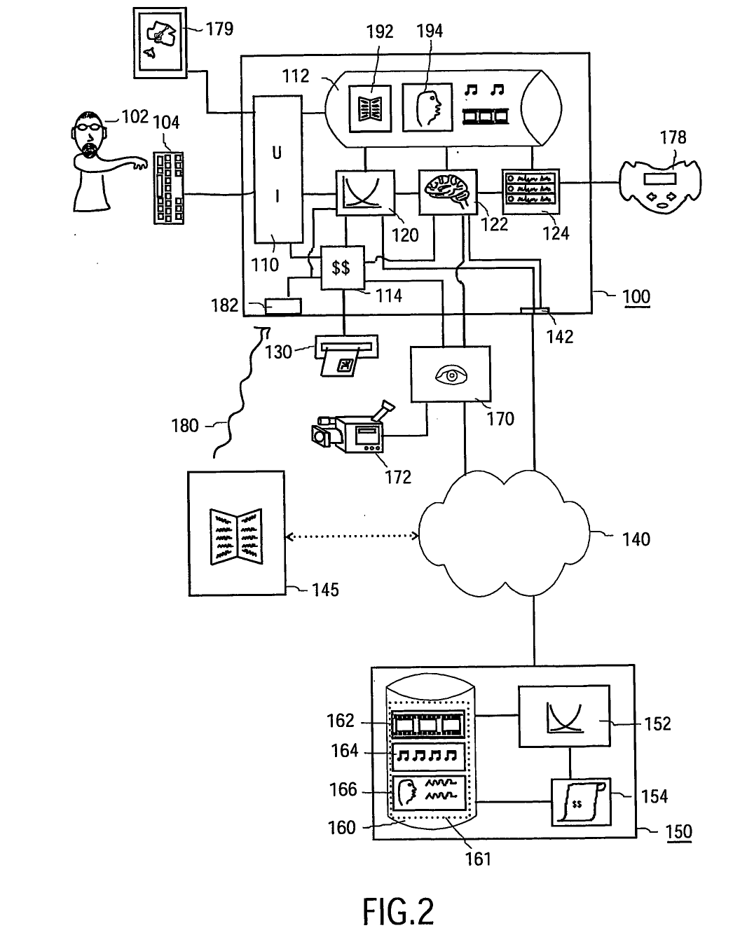

FIG. 2 schematically shows a more complex embodiment of the multimedia purchasing apparatus;

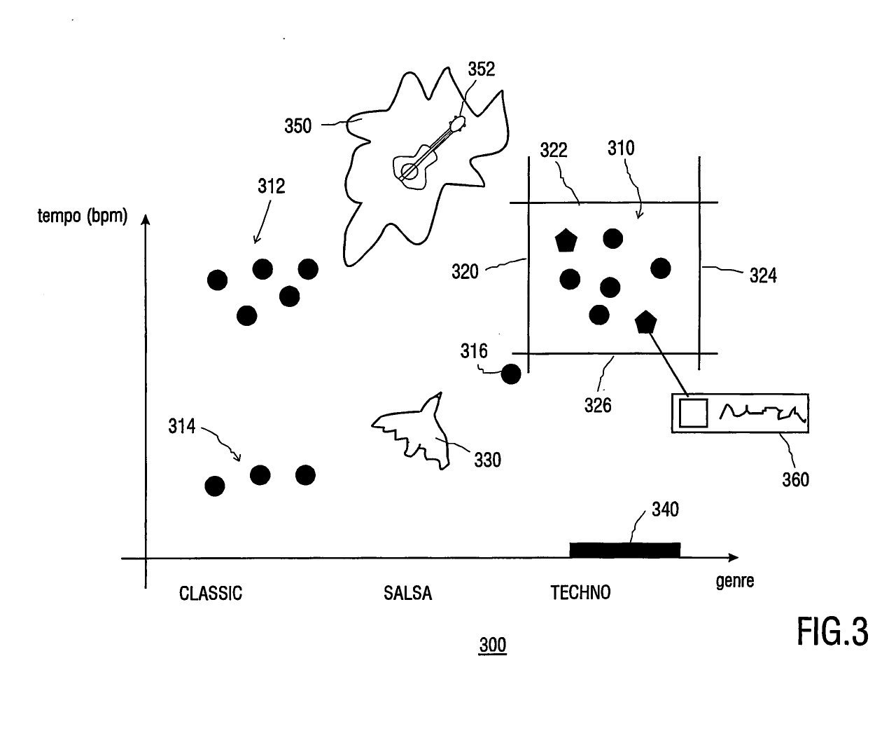

FIG. 3 schematically shows a two dimensional feature space for characterizing pieces of music and a user interface display containing this space;

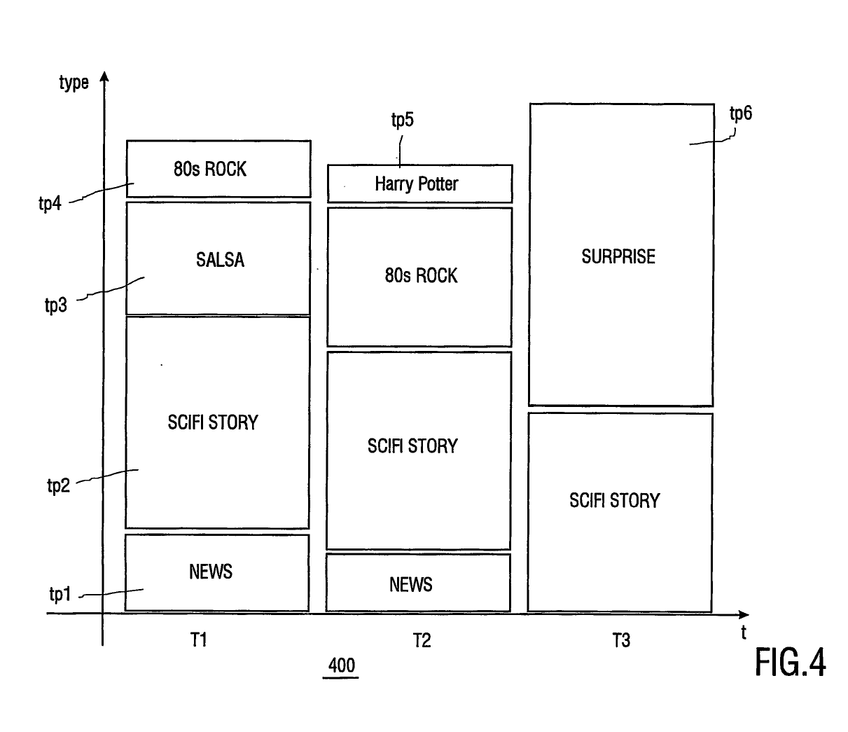

FIG. 4 schematically shows budget specifications for different time periods;

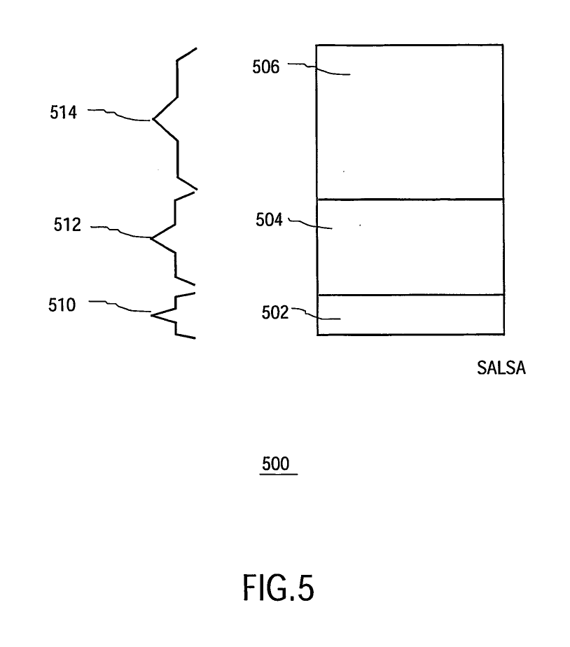

FIG. 5 schematically shows a type budget subdivided in sub ranges; and

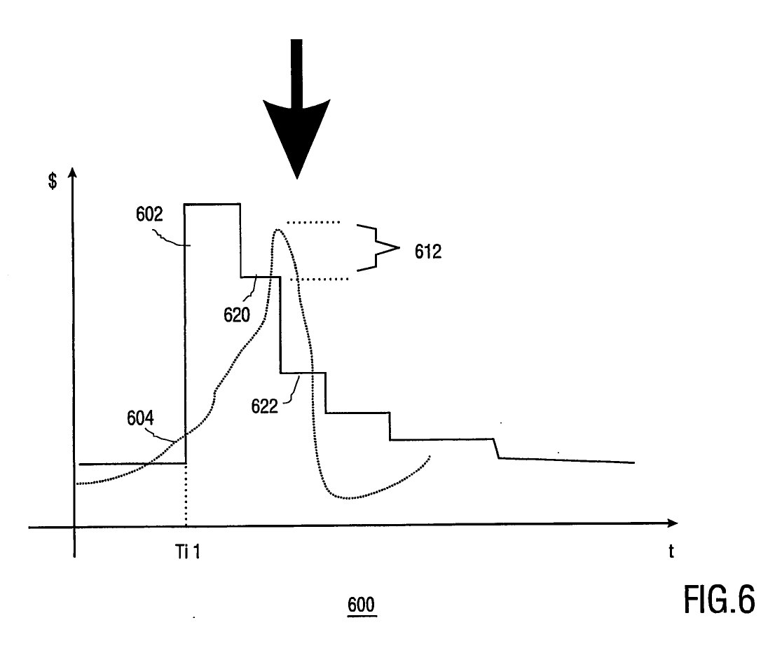

FIG. 6 shows a temporal specification of desired and actual purchasing of a particular multimedia item type.

The multimedia purchasing apparatus 100 of FIG. 1 comprises a user negotiation unit 120, and a budget specification 114 which typically contains limits, or at least guidance figures for the amount of money to spend on multimedia items 161. The user negotiation unit 120 can autonomously purchase a multimedia item over a network 140 by means of a network connector 142, either whatever the price demanded by a content provider 150 (see FIG. 2), or for a price negotiated with one or more content providers 150. The network 140 should be understood in a broad sense as any connection between apparatuses with processing capabilities. E.g., if the multimedia purchasing apparatus 100 is a settopbox or a plug-in electronics board in a settopbox, the network 140 may be a cable television network. If the multimedia purchasing apparatus 100 is comprised in a PC, the network may be the Internet. If it is (part of) a mobile device, such as a mobile audio player, a PDA or a mobile phone, the network 140 may be a wireless telecommunication network or a proprietary wireless network, etc. The network 140 may even be an infrared link between two multimedia purchasing apparatuses 100, e.g. two mobile devices or a mobile device and a PC of two different users, of which one of the apparatuses 100 serves as a temporary, non-commercial provider 150. The apparatus may be connected to different networks, e.g. the Internet, a cable connection to a preselected provider, etc., and search for desired multimedia items on all these networks. The multimedia purchasing apparatus 100 may even be realized so small as to be comprised in a smart card, i.e. making it highly portable. The multimedia items 161 may be of different types, e.g.:
image multimedia 162, such as: a movie, a photograph, a television series, a map, a video course, etc.;
audio multimedia 164, such as: music, a spoken book, a news story, etc.
textual or other multimedia 166, such as: lists of data such as program guides, traffic information, books, code of a computer game, etc.
The items can be paid for according to different purchasing models, e.g.:
a right to view or hear a multimedia item once is purchased;
a right to view or hear a multimedia item a number of times is purchased;
a right to view or hear a multimedia item during a particular period is purchased;
the multimedia item is purchased allowing to store it and use it as many times the user 102 wants;
different multimedia items are purchased together in a package deal;
a user 102 commits himself to purchase a further item within a certain time period;
a user 102 purchases multimedia together with another user; etc.

The different purchasing models may have influence on the cost of the multimedia item. E.g. if more users in a neighborhood purchase the same items, this has an influence on the network traffic towards the neighborhood. Instead of true video on demand at a certain time instant, two users may decide to at least download a movie at the same time, so that it should be transmitted over the network only once. By storing the movie the two users can watch it at different times. A number of friends buying the same multimedia item, may get a price reduction, because the provider so doing avoids that the multimedia item is redistributed in between them for free. A security tag may be attached to the item, so that it can only be used by a particular user, or other security measures may be employed, e.g. a copy indication bit.

In order to be able to purchase the correct multimedia items 161, the user negotiation unit 120 has to know what the user 102 wants. Also important is whether multimedia is bought real time, such as with streaming audio or video, or beforehand. Therefore the user negotiation unit 120 is connected to a user profiling unit 122. The user profiling unit 122 evaluates rules regarding the user 102 stored in a user data 194 part of a database 112 in memory. The user profiling unit 122 may be arranged to have a lot of knowledge about the behavior one or more users 102, both typical behavior of a user and behavior at a specific time instant, e.g. in relation to an occurred event. E.g. the user 102 is in a car. When he is in a car he likes to hear traffic information. The user negotiation unit 120 may given this information start buying traffic information, i.e. spend part of a monthly budget of traffic information.

In the more complex embodiment of FIG. 2, the user profiling unit 122 is connected with a user behavior sensing unit 170, which is arranged to sense the behavior of the user 102, which the user profiling unit 122 can evaluate. E.g., the user behavior sensing unit 170 may have access to a clock and to the item that is played. After performing a statistical analysis, a clearly significant result emerges: the user likes to play soft, slow jazz in the evening, and he likes to have different jazz each evening. The user profiling unit 122 can send this rule, or a simplified rule based on it, such as a list of multimedia items to purchase, to the user negotiation unit 120, which can purchase slow jazz for the coming evenings, and when the price is at its best. The user 102 may be preoccupied with music for a coming or ongoing party, but the user behavior sensing unit 170 may have access to the user's electronic calendar and program guides—e.g. of a movie theatre—, and knowing in advance that a DVD of star wars is coming out, it may inform the user profiling unit 122, which can purchase or order this DVD. The user behavior sensing unit 170 may be coupled to many other software and hardware units, such as e.g. a financial program of the user 102, smart house appliances like a camera 172, access control systems—e.g. an electronic garage door—, a smart microwave oven—indicating that the user 102 will be eating soon—, etc. It may also be linked with the network 140, so that it can communicate information e.g. with computers at the user's 102 work location. Or it may be communicating with a computer in a shop, so that it knows that the user has bought a CD of Madonna there. The user behavior sensing unit 170 may also be allowed to directly re-specify the budget specification 114. E.g. with a hierarchical budget for some types, a user can put an absolute upper spending limit for that multimedia type. The initial budget is set at a first budget level 502 (FIG. 5), and the user behavior sensing unit 170, possibly in cooperation with the user profiling unit 122, can re-specify the budget, e.g. specify a second budget level 504, anywhere in between the first level and the upper spending limit, depending on e.g. how many science fiction movies are released that month, or how many people will come to a party, etc. Budgets may also be specified partly autonomously based on the frequency a user listens to or views particular multimedia types.

As described above, the user profiling unit 122 knows what the user likes, e.g.: the user likes slow jazz in the evening. An entertainment coordination unit 124 can transform this information—knowing that it is evening—in a schedule of multimedia items such as a playlist. It constructs based on this knowledge a consecutive list of slow jazz songs to play at particular times in the evening. It may also construct a consecutive playlist of high tempo songs to download to a portable device 178, e.g. a portable audio player, a mobile phone, or a portable computer. When the user goes jogging in the morning with his portable audio player and headphones, he has songs of appropriate tempos. Songs to download are preferably compressed, e.g. MP3, AAC, etc.

A verification unit 130 may be attached to the multimedia purchasing apparatus 100, either fixed, or connected when required, by means of a fixed connector. The verification unit 130 is arranged to verify if a user is allowed to allocate a budget to the apparatus 100. Multiple users of the same device may also be verified, in which case the user profiling unit 122 and budget specification 114 are updated for the particular user. Before updating the data may be stored in the database 112. The verification unit may e.g. be a biometric verification unit, working in cooperation with a user interface 110 and/or a data input means 104. E.g. a user's fingerprint may be verified or his retina pattern, etc. The data input means 104 may e.g. be a keyboard or a graphical interface such as a touch screen, or a set of knobs and sliders, etc. With the user interface 110 the user can set his preferences in a feature space such as explained below with the aid of FIG. 3. He may also use the user interface 110 and the data input means 104 to specify the budgets for different multimedia types at certain times as in FIG. 4, i.e. he e.g. types a number specifying the size of each budget. The budgets may also be replenished by means of a debit card containing a rechargeable amount of money, of which some is transferred to the budget specification 114. The verification unit 130 may be realized as any other combination of a security system and/or a pay system known from prior art.

Given the knowledge of the user preferences by the user profiling unit 122, the user negotiation unit 120 is arranged to use these rules to actually buy the desired multimedia 161. A simple user negotiation unit 120, i.e. e.g. a programmable user negotiation unit 120 loaded with a simple task, will e.g. just look on the internet for a particular song. This song may be explicitly requested by the user 102 by means of the user interface 110, but it is typically one of a group of songs corresponding with the user's preference, e.g. slow jazz songs. A more sophisticated version of the user negotiation unit 120 may be arranged to negotiate with a provider negotiation unit 152 of one or more providers 150 on the network, to obtain the desired multimedia at a good price. Any strategy known from the prior art of selling goods may be programmed as rules in the user negotiation unit 120. E.g. the user negotiation unit 120 may be aware that some items or parts of items can be obtained for free or at reduced prices, and only purchase e.g. an additional compression layer, or extra scenes of a movie. The user negotiation unit 120 may also be arranged to propose package deals, e.g. if it has knowledge of the availability of a particular item at a lower price at another provider, it may propose a provider to offer it at a reduced price, in return for buying an extra item. To that end, the database 112 may comprise provider information 192, such as e.g. prices, quality of the multimedia, etc. If the provider 150 accepts the deal, it loads the multimedia from a provider database 160 and transmits it over the network 140 to the apparatus 100. A provider's 150 billing unit 154 knows the price of each multimedia item—possibly changed after negotiation—and transfers money from the budget specification 114 over the network 140, or sends a bill via other means, e.g. a message to the user's bank, a paper bill over the mail each month, etc.

There may also be a number of media information storages 145 on the network, e.g. yellow page sites or other directories of multimedia content sites, advertisement on webpages, broker sites which determine upon request which sites can deliver e.g. metallica music, etc. The user negotiation unit 120 can use these to obtain the desired multimedia 161. If the network is a local wireless network, e.g. in and around a music shop, a suggestion 180 can be beamed to a portable multimedia purchasing apparatus 100, e.g. by means of a radio frequency communication beacon. The suggestion 180 is received by a suggestion reception unit 182 comprised in the apparatus 100, e.g. in the former example a bluetooth receiver. Also peers can make suggestions, e.g. over a mobile phone network. If the suggestions are in tune with the user's preferences, a purchase may ensue.

FIG. 3 schematically shows a two-dimensional feature space for characterizing pieces of music. FIG. 3 also illustrates a displayed part of one of the possible user interfaces 110 that the user 102 can use to specify which multimedia he likes, displaying part of such a feature space. A number of parameters can be used to describe a piece of multimedia. Songs e.g. are often tagged, e.g. the ID3 tag is used for MP3 compressed songs. The first version of ID3 contains information on the title, artist, album and year of the song. It contains also a code indicating the genre of the song, e.g. blues, classic rock, country, dance, etc. Later versions of ID3 contain more information, like e.g. lyrics, which may be very useful if the user 102 likes to make a playlist of songs with as a theme “colors” or “love”. Information can also be added by means of other tags, e.g. by users in user communities or experts from a professional tagging service. They may evaluate parameters like e.g. “mood (happy, sexy, . . . )”, “innovativeness”, “audience type (youth, elderly, office worker, . . . )”, “useful for location type (bedroom, office, . . . )”, “energy of the song”, “theme (e.g. Christmas music)”, “instruments present”, “dominance of percussion”, “language of lyrics”, “song intro type (long guitar solo)”, “top 10”, “dramatic song”, etc. Tags may be obtained from other instances of a song such as e.g. an Radio Data Systems (RDS) tag of radio. Copyright or other right information may also be checked, especially when this results in arriving at the cheapest purchase.

Music can also be analyzed automatically by applying audio processing algorithms, either inside or outside the apparatus 100. E.g. different algorithms are known in the prior art to obtain a tempo of a song, analyze volume changes, pitch, etc.

With this information new groupings leading to new parameters can be made, e.g. by means of the artist tag field, the music can be grouped in further categories such as e.g. female singer, a capella, which may further be verified by audio processing algorithms such as speech analysis algorithms. By means of the release data a playlist of the 80's can be made, or an ethnic playlist may be generated with songs from Africa, or Indian songs etc.

A number of these parameters can be used to form axes in an N dimensional audio feature space. To indicate which songs a user likes, he may specify a cluster by means of boundaries 320, 322, 324 and 326, e.g. by entering numerically limits of the parameters along the axes of the feature space. He so specifies a fast techno cluster 310. Song 316 is also a techno song, but falls outside what the user likes, or it was inaccurately parametrized. Instead of typing numerical values, or turning buttons, moving sliders, etc., a graphical user interface may be easier for the user 102 to specify the songs he desires, since he then has a better overview. FIG. 3 schematically illustrates what such an interface may look like on an optionally attached display screen 179. To travel through the feature space a feature space traversing means 330 may be supplied by the user interface 110, which the user can move. Techniques from pattern analysis may be used to perform an automatic clustering to provide the user with suggestions of limits to set, to automatically position the feature space traversing means 330 to interesting clusters (e.g. by means of a “jump to cluster X” command), or display those dimensions in which the songs are well clustered, e.g. by analyzing within cluster variance and inter cluster variance. Further parameters of songs may be displayed with other characteristics like shape, color, etc. E.g. the fast techno songs shown as circles may be instrumental only, whereas the pentagons may correspond to fast techno with singing. The user may himself give songs of particular clusters a certain look, e.g. by showing them as icons or small images rather than as circles, to be able to better find his way in the feature space. To this end he may represent an entire cluster 350 with a symbolizing picture 352, e.g. salsa containing dominant guitar play. The user interface may be configured so that the user can click on an individual song, and see extra info 360 in a pop up window, such as e.g. a picture of the CD cover and the title of a song. Hence the user can verify which songs are in a cluster, and whether it really contains songs he likes. Since songs can come from different sources, some of the techno songs 340 may not have a tempo associated with them. The user interface 110 can display them as a band on the genre axis. The user can discriminate them by moving into other dimensions and specify clusters in those dimensions, and then e.g. link these clusters with the fast techno cluster 310, to have a final specification of what to purchase for a playlist of the next day. Instead of the user having to tediously input all his preferences manually, the user profiling unit 122 may be arranged to wholly or partly determine the user's 102 preferences itself, e.g. by doing a statistical analysis on the user's listening behavior.

A similar approach can be followed for other multimedia content, e.g. movies can be classified according to genre, the activity in a movie can be determined by means of the frequency of occurrence of scene changes, determined by means of color histograms or motion estimation, etc. News items can be categorized by means of what they are about (e.g. about the middle east, about a natural disaster, local news, sports, . . . ), from which press agency they are, etc. If there is no graphical user interface and/or no display 179, the preference along the axis may be set by turning knobs or shifting sliders, e.g. with some of the knobs specifying the cluster means and others the allowed variance, or turning to a first position being a lower bound and then a second position being an upper bound.

For each of the so specified clusters, or groups of clusters, a corresponding budget can then be specified, which is shown in FIG. 4. FIG. 4 may be what is shown on the display screen 179 if the user goes to a budget specification screen. A number of budgets are specified for different time periods T1, T2, T3, either by the user, the user profiling unit 122 or both. In the example the user 102 is a science fiction fan, hence the science fiction budget—type tp2—is permanently large. The user likes to purchase salsa music to exercise his salsa dancing, and has specified a salsa—tp3—budget for this during a first time period T1. He also likes rock music—tp4—and news—tp1—and specifies a budget for those types too. In or before a second time period T2, a “Harry Potter” movie was played in the movie theatres, so the user profiling unit reserves a budget for “Harry Potter” related items—tp5—, such as the movie, purchased from a video on demand server. Since the user profiling unit 122 upon consulting the financial software of the user 102 realizes that the user has less total budget to spend in the second period T2, it diminishes the budget of the other types. However the user also has a party during the second period, on which he will play 80s rock. In a third period T3 the user 102 is on a holiday. He specifies that he wants to be surprised—items of type tp6—, while a good bargain science fiction story should still be purchased. The surprise purchase can be realized in a number of ways, implementing any browsing kind on a scale of decreasing specification. E.g. songs may be purchased from a vast number of clusters, salsa, rock, jazz, techno etc., but all having the property that they are happy songs, suitable for a holiday, or at the extreme any song may be purchased.

FIG. 5 schematically shows a salsa type budget subdivided in sub ranges. Depending on the importance of the multimedia items, the user 102 may desire to spend different amounts of money. E.g. the system may be in a mode of “buy just a few more”, where some songs are purchased for a party, without necessity. The system may alternatively be in a “collection mode”, where still some Madonna songs are missing which have to be purchased at nearly any price. A first budget level 502 may correspond to typical whimsical buying of a few items of the multimedia type. If the purchase of salsa music becomes more important, because the user wants to exercise his dancing and have at his disposition enough songs to do so, the second budget level 504 may be an average spending level for that month. A more rare song may cost a little more, so the user may specify an absolute limit budget 506 to avoid purchasing running out of hand. If the user specifies the importance of items by means of quotas for each type, the first budget level 502 may be the level for the first ten salsa songs, the second budget level 504 for the next 100, etc.

In FIG. 6 a temporal specification of purchasing is shown. A budget graph 602 specifies the budget for star wars related items. The user behavior sensing unit 170 has information of an event at a time instance Ti1, namely that the user went to see “Star Wars”. Immediately after seeing the movie he is more interested in star wars related items, which is modeled with a discrete exponentially decreasing budget curve. Any other function of a temporal difference between the periods and a time instant Ti1 may be used, e.g. an anticipating function. Also shown is an actual budget spending curve 604. The user negotiation unit 120 is buying items way too fast compared to the budget graph 602, or in general compared to one or more temporal budgets for the star wars type, in this case temporal budgets 620 and 622. Hence the arrow shows a braking action indicating that from then on the purchasing is diminished. This may be done by a number of control algorithms known from the art of control theory, e.g. the purchasing intended by the user negotiation unit 120 may be divided by a factor depending on an absolute difference 612 between the temporal budget for a time period and the actual budget spent. E.g. requests can be put in a queue, ordered according to an importance to the user, and a percentage of less interesting intended purchases is blocked. The braking means 199 will typically be a software program running on a processor, but like all units of the invention it could also be dedicated hardware, such as a part of an ASIC.

Under computer program product should be understood any physical realization of a collection of commands enabling a processor—generic or special purpose—, after a series of loading steps to get the commands into the processor, to execute any of the characteristic functions of an invention. In particular the computer program product may be realized as data on a carrier such as e.g. a disk or tape, data present in a memory, data traveling over a network connection—wired or wireless—, or program code on paper. Apart from program code, characteristic data required for the program may also be embodied as a computer program product.

It should be noted that the above-mentioned embodiments illustrate rather than limit the invention. Apart from combinations of elements of the invention as combined in the claims, other combinations of the elements are possible. Any combination of elements can be realized in a single dedicated element.

In particular, it should be clear to the skilled person that the basic skeleton of the multimedia purchasing apparatus as described in the first claim could be combined in any combination with elements, if desired by the manufacturer or user, selected from:
any combination of different budget specifications;
any negotiation strategy;
any user behavior sensing unit or strategy;
any entertainment coordination unit;
any multimedia presentation unit, such as e.g. a television or audio player;
any network connection;
any user verification unit; and
any suggestion reception mechanism;

The elements can be linked to each other for the information required for them to perform their function being able to be transferred between them. In particular, although for clarity specific functions have been restricted to particular units, other units could take over some of the functionality, or units could be grouped in new super-units.

Any reference sign between parentheses in the claim is not intended for limiting the claim. The word “comprising” does not exclude the presence of elements or aspects not listed in a claim. The word “a” or “an” preceding an element does not exclude the presence of a plurality of such elements.

The invention can be implemented by means of hardware or by means of software running on a processor.

1. A multimedia purchasing apparatus (100) for purchasing a multimedia item (161) over a network (140), interacting with a user profiling unit (122) containing information on user preferences of multimedia, characterized in that a user negotiation unit (120) is comprised, arranged to autonomously purchase the multimedia item (161) guided by a budget specification (114), and that the user profiling unit (122) is comprised in the multimedia purchasing apparatus (100).

2. A multimedia purchasing apparatus (100) as claimed in claim 1, wherein the budget specification (114) comprises type budgets for different types of multimedia item.

3. A multimedia purchasing apparatus (100) as claimed in claim 2, wherein the type budgets are subdivided in sub ranges.

4. A multimedia purchasing apparatus (100) as claimed in claim 2, wherein with at least one of the type budgets is associated a quota of multimedia items of the corresponding type.

5. A multimedia purchasing apparatus (100) as claimed in claim 1, wherein the budget specification comprises budgets for different periods.

6. A multimedia purchasing apparatus (100) as claimed in claim 1, wherein braking means (199) are comprised, arranged to reduce multimedia purchasing when an absolute value of a derivative of a budget spending is above a predefined threshold.

7. A multimedia purchasing apparatus (100) as claimed in claim 1, comprising a user behavior sensing unit (170), arranged to obtain information on behavior of a user.

8. A multimedia purchasing apparatus (100) as claimed in claim 7, wherein a type budget is automatically determined on the basis of the information of the user behavior sensing unit (170).

9. A multimedia purchasing apparatus (100) as claimed in claim 5, wherein the budgets for different periods are determined as a function of a temporal difference between the periods and a time instant (TI1).

10. A multimedia purchasing apparatus (100) as claimed in claim 1, comprising an entertainment coordination unit (124), arranged to produce a schedule of purchased multimedia items (161).

11. A multimedia purchasing apparatus (100) as claimed in claim 1, comprising a verification unit (130) arranged to secure user access to the budget specification (114).

12. A multimedia purchasing apparatus (100) as claimed in claim 1, comprising a suggestion reception unit (182) arranged to receive a suggestion to purchase multimedia items (161).

13. A multimedia purchasing apparatus (100) as claimed in claim 1, comprising a provider database (192), comprising data on providers of multimedia content.

14. A multimedia purchasing apparatus (100) as claimed in claim 13, in which the user negotiation unit (120) is arranged to purchase linked items of multimedia (161) in which at least one item is substantially free of charge.

15. A multimedia purchasing apparatus (100) as claimed in claim 1, in which the user negotiation unit (120) is arranged to propose a package deal for a set of multimedia items (161) to a provider of multimedia content.

16. A method of purchasing a multimedia item (161) over a network (140), taking into account user information from a user profiling unit (122) containing information on user preferences of multimedia, characterized in that the multimedia item (161) is purchased autonomously by a multimedia purchasing apparatus (100), guided by a budget specification (114).

17. A method of supplying a multimedia item (161) over a network (140), taking into account user information from a user profiling unit (122) containing information on user preferences of multimedia, characterized in that the multimedia item (161) is supplied in response to an autonomous purchase request from a multimedia purchasing apparatus (100), guided by a budget specification (114).

18. Computer program product comprising code enabling a processor to execute a method according to claim 16.
